(19) United States
(12) Patent Application Publication
(10) Pub. No.: US 2008/0046974 A1
(43) Pub. Date: Feb. 21, 2008

(54) Method and System Enabling a Client to Access Services Provided by a Service Provider

(75) Inventors: David Minodier, Lannion (FR); Gilles Ivanoff, Trebeurden (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM SA, Paris (FR)

(21) Appl. No.: 10/598,598

(22) PCT Filed: Mar. 2, 2005
(86) PCT No.: PCT/EP05/02191

§ 371 Date: Aug. 17, 2007

(30) Foreign Application Priority Data
Mar. 3, 2004 (FR) 04 290583.6

(51) Int. Cl. G06F 21/20; G06F 15/173

(52) U.S. Cl. 726/4; 709/225

(57) ABSTRACT

A client accesses services provided by a service provider by transmitting and/or receiving information in a point-to-point session with a session concentrator via a telecommunication network. An access control protocol controls access to the services provided by the service provider. A client that does not conform is authorized to access a network for non-conforming clients. A point-to-point session is established between the non-conforming client and the session concentrator. The session concentrator transfers the information transmitted by the non-conforming client to a network for clients that conform to the access control protocol.

The present invention relates to a method and a system for access by a client to services provided by a service provider.

The invention concerns the field of access by a client to services provided by a service provider, in which the client is able to transmit and/or receive information according to a point-to-point transport protocol via a telecommunication network and a session concentrator which is able to transmit and/or receive information according to the point-to-point transport protocol, and in which an access control protocol is used in the telecommunication network to control access to the services provided by the service provider.

In conventional Internet access systems which use connections for example of the DSL type, each client is connected to a Digital Subscriber Line Access Multiplexor which is itself connected to a PPP session concentrator. DSL is the acronym for “Digital Subscriber Line”, and PPP is the acronym for “Point-to-Point Protocol”. A PPP session is a session which is established according to a point-to-point protocol such as, for example, the protocol defined in IETF recommendation RFC 2516. A PPP session concentrator is conventionally referred to as a BAS, the acronym for “Broadband Access Server”. A PPP session concentrator conveys the sessions established by the various clients of the network to the point of presence of the service provider to which they are subscribed.

The telecommunication networks which are used in the prior art are based on ATM technology, ATM being the acronym for “Asynchronous Transfer Mode”. When a new client wishes to subscribe to services offered by a service provider of the DSL type, an ATM virtual channel VC is created by an operator between the DSL modem of the new client and the server BAS. The virtual channels of the clients subscribed to the same service provider, or to a service of the service provider, are grouped into virtual paths or VPs between the different Digital Subscriber Line Access Multiplexors and the PPP session concentrator. Telecommunication networks based on ATM technology are complex and difficult to develop.

The use of networks based on technologies other than ATM is envisaged. Networks of the GigaEthernet type offer a very high bandwidth for information transmission. These networks use authentication protocols for access to a network, such as, for example, the protocol defined in the IEEE 802.1x standard. The authentication protocol as defined in the IEEE 802.1x standard is also referred to as an access control protocol. These telecommunication networks are not compatible with the technologies commonly used in telecommunication networks based on ATM technology, and any use of these networks would require complete modification of the telecommunication network and also of the means available to the clients connected to the telecommunication network. In these telecommunication networks, the clients do not have to establish PPP sessions with a PPP session concentrator.

The object of the invention is to overcome the disadvantages of the prior art by proposing a method and a system for access by a client to services provided by a service provider, in which clients conforming to the protocols used in the telecommunication networks using the point-to-point transport protocol can access the services provided by a service provider via a telecommunication network even if the network which allows access to the services provided by a service provider uses a predetermined access control protocol and/or access to the services provided by a service provider is not subject to the establishment of PPP sessions.

To this end, according to a first aspect, the invention proposes a method for access by a client to services provided by a service provider, the client being able to transmit and/or receive information according to a point-to-point transport protocol via a telecommunication network and a session concentrator which is able to transmit and/or receive information according to the point-to-point transport protocol, characterised in that an access control protocol is used in the telecommunication network to control access to the services provided by the service provider, and in that it comprises the steps of:
determining whether or not the client conforms to the access control protocol,
authorising the client that does not conform to the access control protocol to access a network for non-conforming clients, the network for non-conforming clients being set up on the telecommunication network and allowing access to the session concentrator,
establishing a session between the non-conforming client and the session concentrator according to the point-to-point transport protocol on the network for non-conforming clients,
transferring, by the session concentrator, the information transmitted by the non-conforming client in the established session to a network for clients that conform to the access control protocol, the network for conforming clients being set up on the telecommunication network and allowing access to the services provided by the service provider, and reciprocally.

At the same time, the invention relates to a system for access by a client to services provided by a service provider, the client being able to transmit and/or receive information according to a point-to-point transport protocol via a telecommunication network and a session concentrator which is able to transmit and/or receive information according to the point-to-point transport protocol, characterised in that an access control protocol is used in the telecommunication network to control access to the services provided by the service provider, and in that the system comprises:
means for determining whether or not the client conforms to the access control protocol,
means for authorising the client that does not conform to the access control protocol to access a network for non-conforming clients, the network for non-conforming clients being set up on the telecommunication network and allowing access to the session concentrator,
means for establishing a session between the non-conforming client and the session concentrator according to the point-to-point transport protocol on the network for non-conforming clients,
means for transferring, by the session concentrator, the information transmitted by the non-conforming client in the established session to a network for clients that conform to the access control protocol, the network for conforming clients being set up on the telecommunication network and allowing access to the services provided by the service provider, and reciprocally.

It is thus possible, for a client that is able to transmit and/or receive information according to a point-to-point transport protocol, to access services provided by a service provider even if said client is not compatible with the access control protocol which allows access to the services of service providers. By authorising the client to access a network for non-conforming clients, the client can access a session concentrator which is able to transmit and/or receive information according to the point-to-point transport protocol. The session concentrator can thus transmit the information transmitted by the client to a network for conforming clients and thus allow access to the services provided by the service provider.

According to another aspect of the invention, the session concentrator determines, among the information transmitted by the service provider in the network for conforming clients, information destined for the non-conforming client, and transfers the determined information to the non-conforming client in the established session between the non-conforming client and the session concentrator.

Thus, a non-conforming client is able to receive information from a service provider or a service from a service provider.

According to another aspect of the invention, a number of service providers can be accessed by clients, each service provider being accessible via at least one network for clients that conform to the access control protocol, and the session concentrator determines the network for clients that conform to the access control protocol which allows access to the service provider for the non-conforming client, and transfers the information transmitted by the non-conforming client in the established session to the determined network for conforming clients.

Thus, by using at least one network for conforming clients for each service provider, it is possible to divide the telecommunication network into different networks that are independent from one another.

According to another aspect of the invention, upon establishment of the session between the non-conforming client and the session concentrator, the session concentrator receives at least one broadcast message which is transmitted by the non-conforming client on the network for non-conforming clients, the broadcast message comprising at least the address of the non-conforming client, and the session concentrator transfers on the network for non-conforming clients at least one identification request message destined for the non-conforming client.

Thus, it is possible to determine which non-conforming client is attempting to access the services of the service providers.

According to another aspect of the invention, upon establishment of the session between the non-conforming client and the session concentrator, the session concentrator receives at least one message comprising at least one identifier which is transmitted by the non-conforming client on the network for non-conforming clients, transfers the identifier to an authentication server, obtains an authenticator for the non-conforming client, transfers the authenticator to the authentication server and establishes the session if the authentication server authenticates the non-conforming client.

Thus, it is possible to authorise access to the services offered by the service providers only to clients which are subscribed to the services offered by the service providers.

According to another aspect of the invention, the client accesses the telecommunication network via a Digital Subscriber Line Access Multiplexor, and the Digital Subscriber Line Access Multiplexor determines whether or not the client conforms to the access control protocol.

According to another aspect of the invention, if the client conforms to the access control protocol, the Digital Subscriber Line Access Multiplexor authorises the client that conforms to the access control protocol to access a network for conforming clients, the network for conforming clients being set up on the telecommunication network and allowing access to a service provider.

Thus, the conforming clients can directly access the networks which allow access to a service provider, without it being necessary to establish a PPP session in accordance with the point-to-point transport protocol, such as the protocol according to RFC 2516 for example,

According to another aspect of the invention, a number of service providers can be accessed by clients, each service provider being accessible via at least one network for clients that conform to the access control protocol, and the Digital Subscriber Line Access Multiplexor determines the network for clients that conform to the access control protocol which allows access to the service provider for the conforming client, and transfers the information transmitted by the conforming client to the determined network for conforming clients.

Thus, it is possible to categorise and group the clients together according to the service provider to which they are subscribed, or according to the service to which they are subscribed, and thus to limit the services to which the clients have access.

According to another aspect of the invention, the telecommunication network is a network of the GigaEthernet type, the access control protocol is a protocol of the IEEE 802.1x type, and the point-to-point transport protocol is a protocol in accordance with recommendation RFC 2516.

A network of the GigaEthernet type is a high-speed telecommunication network based on Ethernet technology. A network of the GigaEthernet type allows data transfer at speeds of more than one Gigabit per second.

According to another aspect of the invention, the information transmitted according to the point-to-point transport protocol is in the form of packets, and the session concentrator, before transferring the information transmitted by the non-conforming client in the established session to a network for clients that conform to the access control protocol, forms information frames from the packets.

The invention also relates to computer programs stored on an information support, said programs comprising instructions which make it possible to carry out the method described above when it is loaded and run by a computer system.

The features of the invention that have been mentioned above, along with others, will become more clearly apparent on reading the following description of an example of embodiment, said description being given with reference to the appended drawings, in which:

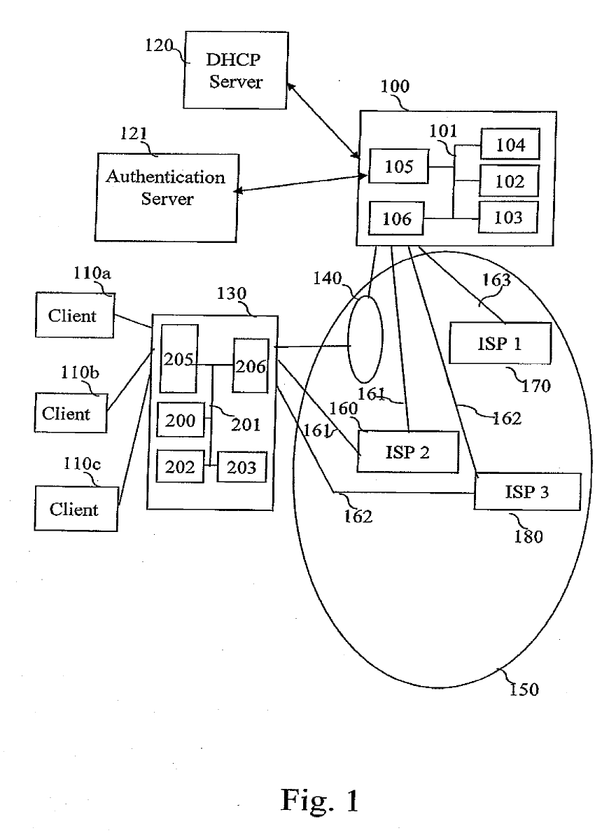

FIG. 1 shows the architecture of the system for access to services provided by service providers by a client that does or does not conform to an access control and authentication protocol via a telecommunication network;

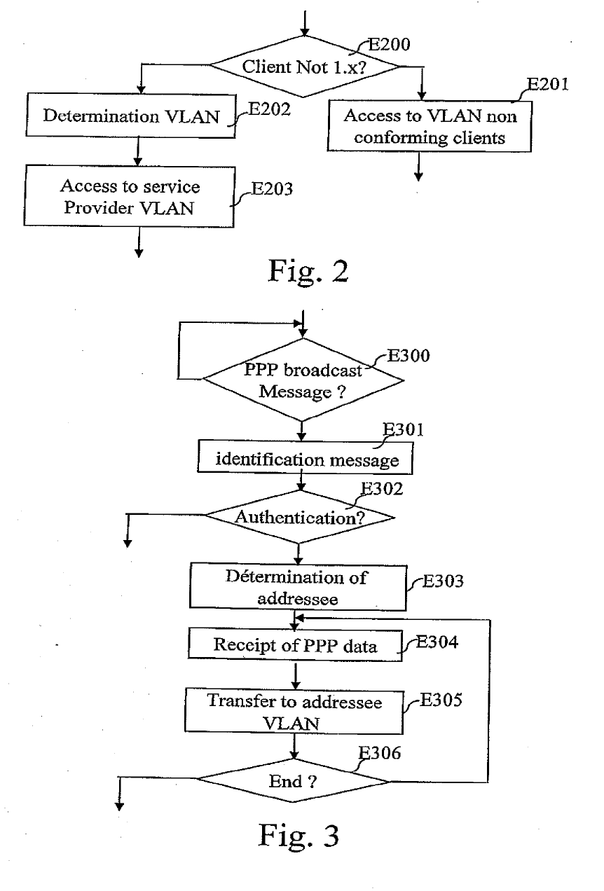

FIG. 2 shows the algorithm used by a Digital Subscriber Line Access Multiplexor of the telecommunication network for access to services provided by service providers by a client that does or does not conform to an access control and authentication protocol;

FIG. 3 shows the algorithm used by a session concentrator of the telecommunication network for access to services provided by service providers by a client that does not conform to an access control and authentication protocol.

FIG. 1 shows the architecture of the system for access to services provided by a service provider by a client that does or does not conform to an access control and authentication protocol via a telecommunication network.

In the system for access to services provided by service providers by a client that does not conform to an access control protocol via a telecommunication network 150, clients 110a, 110b and 110c access service providers 160, 170 and 180 via a Digital Subscriber Line Access Multiplexor 130, a telecommunication network 150 and a session concentrator 100.

According to the invention, the Digital Subscriber Line Access Multiplexor 130 determines whether a client 110 does or does not conform to an access control protocol and orients the communications of the non-conforming client 110 towards a network for clients that do not conform to the access control protocol. The network for clients that do not conform to the access control protocol is preferably a virtual network set up on the telecommunication network 150. The network for non-conforming clients 140 may also, as a variant, be a physical network that is separate from the telecommunication network 150.

The Digital Subscriber Line Access Multiplexor 130 comprises a communication bus 201 to which a central processing unit 200, a non-volatile memory 202, a random-access memory 203, a client interface 205 and a network interface 206 are connected.

The non-volatile memory 202 stores the programs which implement the invention, such as the algorithm which will be described below with reference to FIG. 2. The non-volatile memory 202 is for example a hard disk. More generally, the programs according to the present invention are stored in a storage means. This storage means can be read by a computer or a microprocessor 200. This storage means may or may not be integrated in the Digital Subscriber Line Access Multiplexor 130, and may be removable. When the Digital Subscriber Line Access Multiplexor 130 is powered up, the programs are transferred to the random-access memory 203 which then contains the executable code of the invention and also the data necessary for implementing the invention.

The Digital Subscriber Line Access Multiplexor 130 also comprises a telecommunication network interface 206. This interface allows data exchanges to the telecommunication network 150.

The Digital Subscriber Line Access Multiplexor 130 also comprises a client interface 205. In one preferred embodiment, this interface is an interface of the DSL type. The client interface 205 comprises, for each client 110a, 110b and 110c, a dedicated port for point-to-point communications between the Digital Subscriber Line Access Multiplexor 130 and the client 110 connected to this port.

The Digital Subscriber Line Access Multiplexor 130 comprises means for determining whether or not a client 110 conforms to an access control protocol which is used in the telecommunication network 150 to control access to the services provided by the service providers 160, 170 and 180. These determination means are more specifically the processor 200 which executes the instructions of the algorithm of FIG. 2. The Digital Subscriber Line Access Multiplexor 130 also comprises means for authorising the client 110 that does not conform to the access control protocol to access a network for non-conforming clients 140 which is set up on the telecommunication network 150 and allows access to a session concentrator 100.

The session concentrator 100 is more specifically a PPP session concentrator 100. The PPP session concentrator 100 is connected to the network for non-conforming clients 140 and transfers the messaged transmitted by the non-conforming client 110 to a network for conforming clients 161, 162 or 163 after shaping of the messages transmitted by the client 110. A PPP session is a session established according to a point-to-point protocol.

The networks for conforming clients 161, 162 or 163 thus allow access to services provided by service providers 160, 170 and 180. The networks for clients that conform to the access control protocol are preferably virtual networks which are set up on the telecommunication network 150 and in which it is not necessary to establish a PPP session in order to access the services provided by the service providers.

The Digital Subscriber Line Access Multiplexor 130 is connected via its interface 205 to clients 110a, 110b and 110c by dedicated physical connections. If the dedicated physical connections are of the DSL type, the Digital Subscriber Line Access Multiplexor 130 is known by the term DSLAM. DSLAM is the acronym for “Digital Subscriber Line Access Multiplexer”. The Digital Subscriber Line Access Multiplexor 130 has the function of grouping together several client lines 110a, 110b and 110c on a physical support which transports the data exchanged between the clients 110a, 110b and 110c and their respective service providers 160, 170 or 180. The Digital Subscriber Line Access Multiplexor 130 is connected to the telecommunication network 150, which is for example a network of the GigaEthernet type.

Networks for conforming clients 161, 162 and 163 are set up on the telecommunication network 150 between the Digital Subscriber Line Access Multiplexor 130 and each service provider 160 and 180. The information transported on the networks for conforming clients 161, 162 and 163 is transmitted in the form of Ethernet frames. A network for non-conforming clients 140, which is separate from the networks for conforming clients 161, 162 and 163, is also set up for access, by a client that does not conform to an access control protocol, to the services provided by service providers. The access control protocol is more specifically an access control and authentication protocol such as the IEEE 802.1x protocol for example.

The networks for conforming clients 161, 162 and 163 are preferably virtual networks. Virtual networks or VLANS, an acronym for “Virtual Local Area Networks”, make it possible to categorise the clients and thus to limit the resources to which they have access. For example, if the client 110b is a client of the service provider 160, the exchanges between the client 110b and the service provider 160 are carried out via the VLAN synbolised by the connections bearing the reference 161 in FIG. 1.

One or more virtual networks can thus be associated with one or more services of the service provider 160.

More specifically, the clients 110a, 110b and 110c are telecommunication terminals. The clients 110 are connected to the Digital Subscriber Line Access Multiplexor 130 via the public switched telephone network and use DSL-type modulation techniques. Of course, other types of point-to-point connection may be used. For example, and without any limitation, these connections may also be wireless connections or fibre optic connections. A client 110 is for example a telecommunication device such as a computer comprising a communication card suitable for the connection that exists with the Digital Subscriber Line Access Multiplexor 130 or a computer which is connected to an external communication device suitable for the connection that exists with the Digital Subscriber Line Access Multiplexor 130. In FIG. 1, only three clients 110a, 110b and 110c are shown. Of course, a greater number of clients 110 are connected to the Digital Subscriber Line Access Multiplexor 130.

The session concentrator 100, or more specifically the PPP session concentrator 100, is conventionally referred to as a BAS, the acronym for “Broadband Access Server”. The PPP session concentrator 100 conveys the sessions established with the various non-conforming clients 110 to the service provider 160, 170 or 180 to which they are subscribed. For this, the PPP session concentrator 100 is connected to the network for non-conforming clients 140 and is able to detect broadcast messages conforming to the PPP protocol which are transmitted by a non-conforming client 110 on the network for non-conforming clients 140, to establish a session according to the point-to-point transport protocol with the non-conforming client, to determine the service provider to which the non-conforming client is subscribed, and to transfer the information transmitted by the non-conforming client according to the point-to-point transport protocol on the network for non-conforming clients 140 to the network for conforming clients 161 or 162 or 163 to which the service providers 160, 180 and 170 are respectively connected.

The PPP session concentrator 100 determines, among the information transmitted by the service providers 160, 170, 180 in the networks for conforming clients 161, 162 and 163, information destined for the non-conforming clients which have a PPP session established with the PPP session concentrator 100. The PPP session concentrator 100 shapes the determined information in such a way that said information is compatible with the point-to-point transport protocol, and transfers this shaped information in the established session between the client for which this information is intended and the session concentrator.

The PPP session concentrator 100 comprises a communication bus 101 to which a central processing unit 104, a non-volatile memory 102, a random-access memory 103, a server interface 105 and a network interface 106 are connected.

The non-volatile memory 102 stores the programs which implement the invention, such as the algorithm which will be described below with reference to FIG. 3, The non-volatile memory 102 is for example a hard disk. More generally, the programs according to the present invention are stored in a storage means. This storage means can be read by a computer or a microprocessor 104. This storage means may or may not be integrated in the PPP session concentrator 100, and may be removable. When the PPP session concentrator 100 is powered up, the programs are transferred to the random-access memory 103 which then contains the executable code of the invention and also the data necessary for implementing the invention.

The PPP session concentrator 100 also comprises a telecommunication network interface 106 connected to the communication network 150. This interface 106 makes it possible to convey the sessions established with the various non-conforming clients 110 to the service provider 160, 170 or 180 to which they are subscribed.

The PPP session concentrator 100 also comprises a server interface 105 which allows the exchange of information with a DHCP server 120 and an authentication server 121.

The DHCP server 120 distributes IPv4 or IPv6 addresses to the clients 110 that do not conform to the access control protocol when said clients wish to access the services offered by a service provider 160 or 170 or 180. DHCP is the acronym for “Dynamic Host Configuration Protocol”.

In one variant embodiment, the DHCP server 120 is also able to distribute IPv4 or IPv6 addresses to the clients 110 that conform to the access control protocol. According to this variant, the Digital Subscriber Line Access Multiplexor 130 accesses the DHCP server 120 directly.

The authentication server 121 authenticates a client 110 to the PPP session concentrator 100 when the client 110 wishes to access a service provider 160, 170 or 180. This authentication is carried out on the basis of the identifier of the client 110, such as its username, and the provision by the client 110 of an authentication material such as a password. This authentication will be described in greater detail with reference to FIG. 3.

It should also be noted that the DHCP server may also as a variant be a DHCP relay or “proxy” server which redirects the transferred information to DHCP servers (not shown in FIG. 1) which are associated with each service provider 160, 170 and 180.

A proxy is an item of equipment which receives information from a first telecommunication device and transfers it to a second telecommunication device, and, reciprocally, which receives information from the second telecommunication device and transfers it to the first telecommunication device.

The authentication server 121 authenticates a client that does not conform to the access control protocol.

In one variant embodiment, the authentication server 121 is also able to authenticate a client that conforms to the access control protocol. In this variant, the Digital Subscriber Line Access Multiplexor 130 directly accesses the authentication server 121 in order to authenticate a client that conforms to the access control protocol.

Here, authentication of a client refers both to the authentication of the communication terminal 110 or of the user of the communication terminal 110. This authentication is carried out on the basis of the identifier of the client 110, such as its username, and the provision by the client 110 of a password or of an authentication material that has been validated by the authentication server 121.

As a variant, the authentication server 121 may also be an authentication proxy server which redirects the transferred information to authentication servers (not shown in FIG. 1) which are associated with each service provider 160, 170 and 180. According to this variant, each authentication service associated with a service provider stores all the clients that are authorised to access the services offered by the service provider with which it is associated, as well as the identifier and the authentication material for each client.

The service providers 160, 170 and 180 offer different services to their respective clients. These services are for example, and without any limitation, Internet access services, video-on-demand services, e-mail services, telephone-over-Internet services, videoconference-over-Internet services, etc.

FIG. 2 shows the algorithm used by a Digital Subscriber Line Access Multiplexor of the telecommunication network for access to services provided by service providers by a client that does or does not conform to an access control and authentication protocol.

In step E200, the Digital Subscriber Line Access Multiplexor 130 detects the presence of a client 110 on one of the dedicated physical connections. In this step, the processor 200 verifies whether the client is compatible with the access control protocol, such as the IEEE 802.1x protocol for example. This is determined for example by verifying whether the information transmitted by the client 110 conforms to the EAPOL protocol, EAPOL being the acronym for “EAP Over Lan”, wherein EAP is the acronym for “Extensible Authentication Protocol”. More specifically, the processor 200 verifies whether the client conforms to the IEEE 802.1x protocol by verifying whether said client transmits or is able to respond to a frame of the EAPoL-Start type of the IEEE 802.1x protocol. In the affirmative, the processor 200 moves to step E202. In the negative, the processor 200 moves to step E201.

In step E201, the Digital Subscriber Line Access Multiplexor 130 authorises the non-conforming client 110, for example the client 110a, to access a network for non-conforming clients 140.

In step E202, the Digital Subscriber Line Access Multiplexor 130, more specifically the processor 200, determines the network for clients that conform to the access control protocol 161 or 162 which allows access to the service provider 160 or 180 for the conforming client 110.

In step E203, the Digital Subscriber Line Access Multiplexor 130, more specifically the processor 200, authorises the conforming client 110, for example the client 110b, to access the network for conforming clients 161 or 162 to which its service provider 160 or 180 is connected. The information transmitted by the conforming client 110b is then transferred to the determined network for conforming clients. It should be noted that access authorisation is in this case subject to an authentication procedure.

During the authentication procedure, the Digital Subscriber Line Access Multiplexor 130, more specifically the processor 200, receives from the client 110 an identifier and a password or an authentication material.

The processor 200 of the Digital Subscriber Line Access Multiplexor 130 commands the transfer of a registration confirmation request to the authentication server 121. The authentication server 121 searches in the client database to determine whether the client 110 is contained in the client database, verifies the validity of the password or of the authentication material and, in the affirmative, transfers a confirmation of registration of the client 110 to the Digital Subscriber Line Access Multiplexor 130. The authentication procedure preferably conforms to the procedure described in the IEEE 802.1x protocol.

It should also be noted here that the Digital Subscriber Line Access Multiplexor 130, having verified that the clients conform to an access control protocol, authorises said clients to access a network 161 or 162 in which PPP sessions are not used for access to the services provided by the service providers 160 or 180. The Digital Subscriber Line Access Multiplexor 130, upon determining that the clients do not conform to an access control protocol, authorises said clients to access a network 140 in which PPP sessions can be used for access to the services provided by the service providers 160, 170 or 180.

FIG. 3 shows the algorithm used by a session concentrator of the telecommunication network for access to services provided by service providers by a client that does not conform to an access control and authentication protocol.

Step E300 consists of a waiting loop in which, more specifically, the processor 104 waits to receive a broadcast message from the network for non-conforming clients 140. The broadcast message conforms for example to the PPP protocol or to one of its two variants (PPPoE (acronym for “Point to Point Protocol over Ethernet”) and PPPoA (acronym for “Point to Point Protocol over ATM”). The point-to-point transport protocol PPP makes it possible to transport multi-protocol datagrams via a point-to-point connection. The broadcast message is transmitted by a non-conforming client on the network for non-conforming clients 140. This is because, according to the PPP protocol, each PPP session has to learn the Ethernet address of the remote machine so as to establish and identify a unique session. This broadcast message comprises the address of the non-conforming client 110, the predetermined addressee address, identified as the broadcast address, and a session identifier. Upon receipt of a broadcast message, the PPP session concentrator 100 moves to the next step E301.

In this step, an identification message is sent by the PPP session concentrator 100, more specifically by the processor 104, to the client 110 whose broadcast message has previously been detected via the virtual network 140.

The next step E302 is a step of interpreting, more specifically by the processor 104, the result of the authentication request for the client 110. The result of the authentication request is delivered by the authentication server 121. Whether or not a PPP session is established between the client and the session concentrator depends on the result of the authentication request. If this session is established, it will make it possible de facto for the client to access the services of the service provider 160, 180 or 170. If the authentication of the client 110 has failed, the PPP session concentrator 100 does not allow the establishment of the session between the client 110 and the PPP session concentrator 100. The client is thus unable to access any of the service providers 160, 170 and 180.

More specifically, the PPP session concentrator 100 receives at least one message comprising at least one identifier which is transmitted by the client 110 on the network for non-conforming clients 140, the PPP session concentrator 100 transfers the identifier to the authentication server 121 which may or may not recognise the client 110 as having an identifier that is known to the authentication server 121. If the authentication server 121 recognises the client 110, it generates a message destined for the PPP session concentrator 100 so that the latter obtains the authenticator for the client 110. Once the PPP session concentrator 100 has obtained this authenticator for the client 110, the authenticator is transferred to the authentication server 121 which may or may not authenticate the client 110. If authentication of the client 110 is confirmed, the PPP session concentrator 100 moves to the next step E303.

The PPP session concentrator 100, more specifically by the processor 104, determines in step E303 the service provider to which the client 110 is subscribed. This is carried out for example by analysing the identification message previously received from the client in step E302.

In step E304, the PPP session is established between the client 110 and the PPP session concentrator 100. The PPP session concentrator 100, more specifically by the processor 104, receives from the client 110, via the virtual network 140, information conforming to the point-to-point transport protocol.

The PPP session concentrator 100, more specifically by the processor 104, then in step E305 transfers the information received on the network for conforming clients 161, 162 or 163 corresponding to the service provider to which the client 110 is subscribed. It should be noted here that the information transported in the form of packets, in accordance with the point-to-point transport protocol, is previously shaped so as to form frames of the Ethernet type. It should also be noted that a packet consists of a frame of the Ethernet type encapsulated in accordance with the PPP protocol.

Once this operation is complete, the PPP session concentrator 100, more specifically by the processor 104, returns to step E304 and carries out the loop consisting of steps E304 to E306 for as long as the PPP session between the client 110 and the session concentrator 100 remains established. The PPP session is interrupted if the client 110 disconnects in accordance with the PPP protocol or if an exceptional event occurs. This event is for example an explicit order sent to the PPP session concentrator 100 to interrupt a session, the failure of a link in the network for non-conforming clients 140, or the like.

It should be noted here that the PPP session concentrator 100, in parallel with steps E304 and E306, determines, among the information transmitted by the service providers 160, 170, 180 in the networks for conforming clients 161, 162 and 163, the information destined only for the non-conforming clients which have a PPP session established with the PPP session concentrator 100. The PPP session concentrator 100 shapes the determined information so that said information is compatible with the point-to-point transport protocol, and transfers this shaped information in the established session between the client for which this information is intended and the session concentrator.

Of course, the present invention is in no way limited to the embodiments described here but rather, on the contrary, encompasses any variant within the capabilities of the person skilled in the art.

1. Method for access by a client to services provided by a service provider, the client being able to transmit and/or receive information according to a point-to-point transport protocol via a telecommunication network and a session concentrator which is able to transmit and/or receive information according to the point-to-point transport protocol, the method being performed by using an access control protocol in the telecommunication network to control access to the services provided by the service provider, the method comprising
determining whether or not the client conforms to the access control protocol,
authorising the client that does not conform to the access control protocol to access a network for non-conforming clients, the network for non-conforming clients being set up on the telecommunication network and allowing access to the session concentrator,
establishing a session between the non-conforming client and the session concentrator according to a point-to-point transport protocol on the network for non-conforming clients,
transferring, by the session concentrator, the information transmitted by the non-conforming client in the established session to a network for clients that conform to the access control protocol, the network for conforming clients being set up on the telecommunication network and allowing access to the services provided by the service provider, and reciprocally.

2. Method according to claim 1, wherein the method furthermore comprises the steps, carried out by the session concentrator, of:
determining, among the information transmitted by the service provider in the network for conforming clients, information destined for the non-conforming client,
transferring the determined information to the non-conforming client in the established session between the non-conforming client and the session concentrator.

3. Method according to claim 1, wherein a number of service providers can be accessed by clients, each service provider being accessible via at least one network for clients that conform to the access control protocol, and the method furthermore comprising determining the network for clients that conform to the access control protocol which allows access to the service provider for the non-conforming client, the determing step being carried out by the session concentrator, and transferring the information transmitted by the non-conforming client in the established session to the determined network for conforming clients.

4. Method according to claim 1, wherein the step of establishing the session between the non-conforming client and the session concentrator includes sub-steps, carried out by the session concentrator, of:
receiving at least one broadcast message which is transmitted by the client on the network for non-conforming clients, the broadcast message comprising at least the address of the client,
transferring on the network for non conforming clients at least one identification request message destined for the non-conforming client.

5. Method according to claim 4, wherein the step of establishing the session between the client and the session concentrator furthermore comprises sub-steps, carried out by the session concentrator, of
receiving at least one message comprising at least one identifier which is transmitted by the client on the network for non-conforming clients,
transferring the identifier to an authentication server,
obtaining an authenticator for the client and transferring the authenticator to the authentication server,
establishing the session if the authentication server authenticates the client.

6. Method according to claim 1, wherein the client accesses the telecommunication network via a Digital Subscriber Line Access Multiplexor, and the Digital Subscriber Line Access Multiplexor determines whether or not the client conforms to the access control protocol.

7. Method according to claim 6, wherein if the client conforms to the access control protocol, the Digital Subscriber Line Access Multiplexor authorises the client that conforms to the access control protocol to access a network for conforming clients, the network for conforming clients being set up on the telecommunication network and allowing access to a service provider.

8. Method according to claim 7, wherein a number of service providers can be accessed by clients, each service provider being accessible via at least one network for clients that conform to the access control protocol, and the method furthermore comprises determining the network for clients that conform to the access control protocol which allows access to the service provider for the conforming client, the determining step being carried out by the Digital Subscriber Line Access Multiplexor, and transferring the information transmitted by the conforming client to the determined network for conforming clients.

9. Method according to claim 7, wherein the telecommunication network is a network of the GigaEthernet type, the access control protocol is a protocol of the 8021x type, and in that the point-to-point transport protocol is a protocol in accordance with recommendation RFC 2516.

10. Method according to claim 9, wherein the information transmitted according to the point-to-point transport protocol is in the form of packets, and the session concentrator, before transferring the information transmitted by the non-conforming client in the established session to a network for clients that conform to the access control protocol, forms information frames from the packets.

11. System for access by a client to services provided by a service provider, the client being able to transmit and/or receive information according to a point-to-point transport protocol via a telecommunication network and a session concentrator which is able to transmit and/or receive information according to the point-to-point transport protocol, the telecommunication network including an access control protocol to control access to the services provided by the service provider, the system comprising:
means for determining whether or not the client conforms to the access control protocol,
means for authorising the client that does not conform to the access control protocol to access a network for non-conforming clients, the network for non-conforming clients being set up on the telecommunication network and allowing access to the session concentrator,
means for establishing a session between the client and the session concentrator according to the point-to-point transport protocol on the network for non-conforming clients,
means for transferring, by the session concentrator, the information transmitted by the non-conforming client in the established session to a network for clients that conform to the access control protocol, the network for conforming clients being set up on the telecommunication network and allowing access to the services provided by the service provider, and reciprocally.

12. A computer readable medium or storage device including a computer program, said program comprising instructions for enabling a computer to carry out the method according to claim 1 when it is loaded and run by a computer system.
